(19) United States
(12) Patent Application Publication
(10) Pub. No.: US 2013/0224469 A1
(43) Pub. Date: Aug. 29, 2013

(54) COATED ARTICLE AND METHOD FOR MAKING THE COATED ARTICLE

(71) Applicants: REN-BO WANG, Shenzhen City (CN); YONG-GANG ZHU, Shenzhen City (CN); XIAO-MEI CHEN, Shenzhen City (CN); XIN-WU GUAN, Shenzhen City (CN); PO-FENG HO, Shindian (TW)

(72) Inventors: REN-BO WANG, Shenzhen City (CN); YONG-GANG ZHU, Shenzhen City (CN); XIAO-MEI CHEN, Shenzhen City (CN); XIN-WU GUAN, Shenzhen City (CN); PO-FENG HO, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/614,568

(22) Filed: Sep. 13, 2012

(30) Foreign Application Priority Data
Feb. 23, 2012 (CN) 201210041916.2

(51) Int. Cl. B32B 15/04; B32B 37/06

(52) U.S. Cl. 428/293.4; 156/272.2

(57) ABSTRACT

A coated article includes a metallic substrate, a fiber layer directly formed on the metallic substrate, and an enamel layer directly formed on the fiber layer. The enamel layer mainly contains silicon oxide, aluminum oxide, sodium oxide, potassium oxide, and fiber reinforced composite. A method for making the coated article is also described.

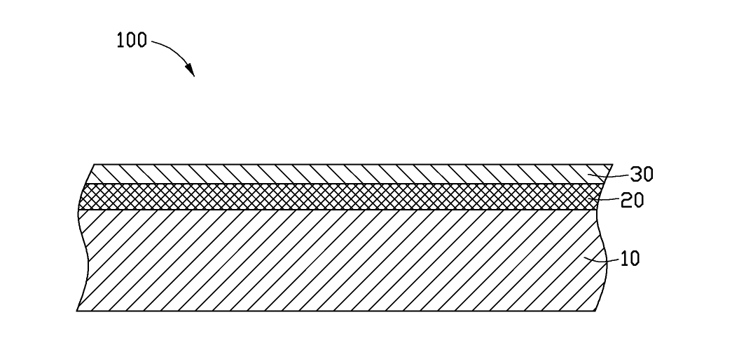

### BACKGROUND

1. Technical Field

The present disclosure relates to coated article and a method for making the coated article.

2. Description of Related Art

Housings of electronic devices, such as mobile phones, are commonly covered by decorative layers. The decorative layer may be an enamel layer formed by electrostatic adsorption. However, the enamel layers of related art formed by electrostatic adsorption poorly bond to the substrate of the housing. Furthermore, the enamel layers have poor shock resistance and low toughness.

Therefore, there is room for improvement within the art.

### BRIEF DESCRIPTION OF THE DRAWING

Many aspects of the disclosure can be better understood with reference to the following FIGURE. The components in the FIGURE are not necessarily drawn to scale, the emphasis instead being placed upon clearly illustrating the principles of the disclosure.

The FIGURE is a cross-sectional view of an exemplary embodiment of a coated article.

### DETAILED DESCRIPTION

Referring to the FIGURE, a coated article 100 according to an exemplary embodiment is shown. The coated article 100 includes a metallic substrate 10, a fiber layer 20 directly formed on the metallic substrate 10, and an enamel layer 30 directly formed on the fiber layer 20. As used herein, “directly” means a surface of one layer contacts a surface of the other layer.

The metallic substrate 10 may be made of stainless steel or titanium alloy, for example.

The material of the fiber layer 20 may be one or more selected from a group consisting of carbon fiber, glass fiber, and boron fiber.

The enamel layer 30 mainly comprises silicon oxide, aluminum oxide, sodium oxide, potassium oxide, and fiber reinforced composite. The enamel layer 30 may further comprise a small quantity of iron oxide, calcium oxide, magnesium oxide, and titanium oxide. In the enamel layer 30, the silicon oxide may have a mass percentage of about 60% to about 70%, the aluminum oxide may have a mass percentage of about 15% to about 20%, the sodium oxide may have a mass percentage of about 4% to about 6%, the potassium oxide may have a mass percentage of about 4% to about 6%, and the fiber reinforced composite may have a mass percentage of about 8% to about 15%. The fiber reinforced composite comprises the same materials as that of the fiber layer 20, which enhances the bond between the fiber layer 20 and the enamel layer 30. The enamel layer 30 may have a thickness of about 0.15 mm to about 0.35 mm. The enamel layer 30 can be formed by electrostatic adsorption, for example.

A method for making the coated article 100 may include the following steps.

The metallic substrate 10 is provided and cleaned.

The metallic substrate 10 is sandblasted to clean and roughen the surface of the metallic substrate 10. The roughened surface of the metallic substrate 10 enhances the bond between the metallic substrate 10 and the fiber layer 20.

A press device (not shown) is provided. A fiber net (not shown) for forming the fiber layer 20 is also provided. The fiber net has a thickness of about 0.03 mm to about 0.06 mm. The fiber net is spread on one surface of the metallic substrate 10 and then positioned in the press device to be bonded on the metallic substrate 10. During the pressing process, the press device has a pressure of about 80 MPa to about 150 MPa. The pressing process may last for about 10 minutes to about 30 minutes. After the pressing process, the fiber layer 20 is formed on the metallic substrate 10.

The metallic substrate 10 and bonded fiber layer 20 are punched to a design shape of the coated article 100. The surface of the fiber layer 20 may be subjected a rinsing and a sand blasting treatment to roughen the surface of the fiber layer 20.

An electrostatic adsorption device (not shown) and spraying powder for forming the enamel layer 30 are provided. The spraying powder comprises the same constituents as those of the enamel layer 30.

The metallic substrate 10 and bonded fiber layer 20 are positioned in the electrostatic adsorption device. Then the electrostatic adsorption device is turned on to spray the powder on the fiber layer 20 and form the enamel layer 30. The enamel layer 30 has a deposited thickness of about 0.015 mm to about 0.035 mm.

The coated article 100 is then heated in an oven (not shown) having an internal temperature of about 780° C. for about 10 minutes to about 30 minutes. The heating makes the fiber layer 20 and the enamel layer 30 thermocoagulate and bond strongly with each other.

After being heated, the coated article 100 is removed from the oven and allowed to cool naturally. After cooling, the coated article 100 may further be grinded and then polished to obtain a smooth surface.

The coated article 100 of the exemplary embodiment defines a fiber layer 20 between the metallic substrate 10 and the enamel layer 30, which greatly enhances the bond between the enamel layer 30 and the metallic substrate 10. Furthermore, the fiber layer 20 eliminates any stress concentration in the coated article 100. When subject to impacts, the fiber layer 20 diffuses the force of the impact since the fiber layer 20 has a reticulated structure. As a result, the crack resistance and shock resistance of the coated article 100 is improved. Additionally, the fiber reinforced composite contained in the enamel layer 30 further enhances the strength and bond toughness of the enamel layer 30 because of the reticulated aspect of the fiber reinforced composite. The fiber reinforced composite of the enamel layer 30 further enhances the crack resistance and shock resistance of the enamel 30 and thus the coated article 100.

Specific examples of making the coated article 100 are described below. The cleaning and blasting of the metallic substrate 10 in these specific examples is as described above and always the same. The specific examples mainly emphasize the different process parameters of forming the fiber layer 20 and the enamel layer 30.

### Example 1

The metallic substrate 10 was made of stainless steel.

In forming the fiber layer 20: the pressing device had a pressure of about 150 MPa and the pressing process lasted for about 10 minutes.

In forming the enamel layer 30: the spraying powder mainly comprised silicon oxide, aluminum oxide, sodium oxide, potassium oxide, and glass fiber. The spraying powder further comprised a small quantity of iron oxide, calcium oxide, magnesium oxide, and titanium oxide. In the spraying powder, the silicon oxide had a mass percentage of about 60%, the aluminum oxide had a mass percentage of about 15%, the sodium oxide had a mass percentage of about 5%, the potassium oxide had a mass percentage of about 5%, and the glass fiber had a mass percentage of about 10%. The enamel layer 30 had a thickness of about 0.02 mm.

In the heat treatment: the coated article 100 was heated in the oven having an internal temperature of about 680° C. for about 30 minutes.

### Example 2

The metallic substrate 10 was made of stainless steel.

In forming the fiber layer 20: the pressing device had a pressure of about 130 MPa and the pressing process lasted for about 30 minutes.

In forming the enamel layer 30: the spraying powder mainly comprised silicon oxide, aluminum oxide, sodium oxide, potassium oxide, and glass fiber. The spraying powder further comprised a small quantity of iron oxide, calcium oxide, magnesium oxide, and titanium oxide. In the spraying powder, the silicon oxide had a mass percentage of about 60%, the aluminum oxide had a mass percentage of about 15%, the sodium oxide had a mass percentage of about 5%, the potassium oxide had a mass percentage of about 5%, and the glass fiber had a mass percentage of about 10%. The enamel layer 30 had a thickness of about 0.025 mm.

In the heat treatment: the coated article 100 was heated in the oven having an internal temperature of about 780° C. for about 10 minutes.

### Results

A drop test and a salt spray test were performed on the coated articles 100 formed by the examples 1-2.

The drop test was carried out by repeatedly (about 300 times) dropping the coated articles 100 from a height of 1 meter. No cracks were found in the enamel layers 30 of the coated articles 100.

The salt spray test was carried out using a sodium chloride (NaCl) solution having a mass concentration of 5% and a temperature of 35° C. The test indicated that the corrosion resistance property of the coated articles 100 over time was longer than 168 hours. These test samples further indicated no cracking of the enamel layers 30 after being subjected the drop test, and the coated article 100 had good corrosion resistance properties.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A coated article, comprising:
a metallic substrate;
a fiber layer directly formed on the metallic substrate; and
an enamel layer directly formed on the fiber layer, the enamel layer mainly comprising silicon oxide, aluminum oxide, sodium oxide, potassium oxide, and fiber reinforced composite.

2. The coated article as claimed in claim 1, wherein components of the fiber reinforced composite are the same as those of the fiber layer, the component is one or more selected from a group consisting of carbon fiber, glass fiber, and boron fiber.

3. The coated article as claimed in claim 2, wherein in the enamel layer, the silicon oxide has a mass percentage of about 60% to about 70%, the aluminum oxide has a mass percentage of about 15% to about 20%, the sodium oxide has a mass percentage of about 4% to about 6%, the potassium oxide has a mass percentage of about 4% to about 6%, and the fiber reinforced composite has a mass percentage of about 8% to about 15%.

4. The coated article as claimed in claim 1, wherein the enamel layer further comprises iron oxide, calcium oxide, magnesium oxide, and titanium oxide.

5. The coated article as claimed in claim 1, wherein the enamel layer has a thickness of about 0.015 mm to about 0.035 mm.

6. The coated article as claimed in claim 1, wherein the fiber layer has a thickness of about 0.03 mm to about 0.06 mm.

7. The coated article as claimed in claim 1, wherein the metallic substrate is made of stainless steel or titanium alloy.

8. A method for making a coated article, comprising:
providing a metallic substrate;
providing a fiber net and pressing the fiber net on the metallic substrate to form a fiber layer;
forming an enamel layer on the fiber layer by electrostatic adsorption using spraying powder, the spraying powder mainly comprising silicon oxide, aluminum oxide, sodium oxide, potassium oxide, and fiber reinforced composite;
heating the enamel layer and the fiber layer to form the coated article.

9. The method as claimed in claim 8, wherein pressing the fiber net on the metallic substrate is carried out under a pressure of about 80 MPa to about 150 MPa and lasts for about 10 minutes to about 30 minutes.

10. The method as claimed in claim 8, wherein in the spraying powder, the silicon oxide has a mass percentage of about 60% to about 70%, the aluminum oxide has a mass percentage of about 15% to about 20%, the sodium oxide has a mass percentage of about 4% to about 6%, the potassium oxide has a mass percentage of about 4% to about 6%, and the fiber reinforced composite has a mass percentage of about 8% to about 15%.

11. The method as claimed in claim 8, wherein the heating process is carried out at a temperature of about 780° C. for about 10 minutes to about 30 minutes.

12. The method as claimed in claim 8, wherein the method further comprises a step of sand blasting the metallic substrate before pressing the fiber net on the metallic substrate.

13. The method as claimed in claim 8, wherein components of the fiber reinforced composite are the same as those of the fiber layer, the component is one or more selected from a group consisting of carbon fiber, glass fiber, and boron fiber.

14. The method as claimed in claim 8, wherein the spraying powder further comprises iron oxide, calcium oxide, magnesium oxide, and titanium oxide.

15. The method as claimed in claim 8, wherein the enamel layer has a thickness of about 0.015 mm to about 0.035 mm.

16. The method as claimed in claim 8, wherein the fiber layer has a thickness of about 0.03 mm to about 0.06 mm.

17. The method as claimed in claim 8, wherein the metallic substrate is made of stainless steel or titanium alloy.
